(19) United States
(12) Patent Application Publication
(10) Pub. No.: US 2023/0236899 A1
(43) Pub. Date: Jul. 27, 2023

(54) DYNAMIC WORKLOAD PLACEMENT USING CLOUD SERVICE ENERGY IMPACT

(71) Applicant: Cisco Technology, Inc., San Jose, CA (US)

(72) Inventors: Robert Edgar Barton, Richmond (CA); Jerome Henry, Pittsboro, NC (US); Indermeet Singh Gandhi, San Jose, CA (US); Thomas Szigeti, Vancouver (CA)

(21) Appl. No.: 17/582,333

(22) Filed: Jan. 24, 2022

(51) Int. Cl. G06F 9/50; G06F 11/34

(52) U.S. Cl. CPC G06F 9/505; G06F 11/3433

(57) ABSTRACT

This disclosure describes dynamically placing workloads using cloud service energy efficiency. The techniques include obtaining energy efficiency metrics (EEMs) that indicate the carbon footprint for different data centers of cloud service providers. In some configurations, an Energy Efficiency Quotient (EEQ) may be generated by an Energy Telemetry Engine (ETE) that indicates the energy efficiency for each data center/Point of Presence (POP) where a workload may be migrated/hosted. The ETE can be used to rank the different host locations (e.g., different data according to their EEQ. In some examples, one or more other metrics (e.g., latency, bandwidth, . . . ) may be used to identify any POPs that do not meet specified conditions (e.g., latency constraints, bandwidth constraints, . . . ). When a suitable host location is determined (e.g. a POP meets both the performance and EEQ specifications), the workload may be placed onto one or more resources of the selected data center.

### TECHNICAL FIELD

The present disclosure relates generally for dynamically placing workloads in a multi-cloud environment.

### BACKGROUND

Today, there many different cloud service providers that build and use large physical data centers to provide cloud services for customers. The proliferation of cloud services residing in these massive physical data centers is greatly impacting our society, as is the energy impact of these cloud services. These data centers use a large amount of energy. As companies align their business with sustainable practices, they are examining the environmental impact of a cloud service provider. As such, many cloud service providers are now trying to achieve sustainability even as energy requirements for the cloud service providers grow. For example, different cloud service providers may promote their efforts for reducing energy impact to the Earth.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system that uses an energy telemetry engine to assist in dynamically placing workloads using cloud service energy impact.

FIG. 2 illustrates a system that uses an energy telemetry engine to help dynamically place workloads in different cloud services.

FIG. 3 is a flowchart illustrating a process for dynamically placing workloads using cloud service energy impact in a multi-cloud service environment.

FIG. 4 is a flowchart illustrating a process for performing energy analysis for different cloud services.

FIG. 5 illustrates an example computer architecture for a computer capable of executing program components for implementing the functionality described herein.

### DESCRIPTION OF EXAMPLE EMBODIMENTS OVERVIEW

This disclosure describes techniques for dynamically placing workloads using cloud service energy impact. The techniques include obtaining energy efficiency metrics (EEMs) that indicate the energy impact to the earth for different data centers of cloud service providers that can be used to host one or more workloads. In some configurations, an Energy Efficiency Quotient (EEQ) may be generated by an Energy Telemetry Engine (ETE) that indicates the energy impact (e.g., the carbon footprint) for each data center/Point of Presence (POP) where a workload may be migrated/hosted. As used herein, the term “host location” may refer to a “data center” or a “POP” and/or some other server/computing device that may host a workload.

The ETE can be used to rank the different host locations (e.g., different data according to their EEQ. In some examples, one or more other metrics (e.g., latency, bandwidth, . . . ) may be used to identify any POPs that do not meet specified conditions (e.g., latency constraints, bandwidth constraints, . . . ). When a suitable host location is determined (e.g. a POP meets both the performance and EEQ specifications), the workload may be placed onto one or more resources of the selected data center. The techniques described herein may be performed by a system and/or device having non-transitory computer-readable media storing computer-executable instructions that, when executed by one or more processors, performs the methods described herein.

### EXAMPLE EMBODIMENTS

As companies align their business with sustainable practices, they are becoming more interested in reducing their environmental impact. To assist these companies, workloads can be dynamically placed on computing resources associated with a host location to assist in reducing the environmental impact associated with execution of the workloads. As used herein, a “workload” refers to any application, service, or other amount of work that is executed by one or more computing resources of a data center. Some examples of workloads include, but are not limited to general compute workloads (e.g., web applications, web applications, web servers, data stores, containerized microservices, . . . ), CPU intensive workloads (e.g., machine learning applications, highly scalable applications), memory intensive workloads (e.g., distributed databases, caches, real-time streaming, . . . ), GPU accelerated workloads (e.g., autonomous vehicles, speech recognition, . . . ), and the like.

In some examples, a workload may be an “application”, a “cloud-native application”, and/or some other unit of work to be executed. A cloud-native application can include a collection of small, independent, and loosely coupled services. Many cloud-native applications employ a microservice architecture. In a monolithic architecture, an application can be built as a single deployable unit. By contrast, in a microservice architecture, a complex system may be split into multiple independent, narrowly focused services, each with its own isolated business logic and data store. In some examples, services of the cloud-native application may be distributed across different cloud environments including one or more public cloud environments, and one or more private networks. In a microservice architecture, typically, any service can be scaled and deployed separately. In these cases, one or more public cloud environments, and/or one or more private networks can host one or more workloads.

A workload may be hosted by one or more physical computing resources (e.g., one physical machine, two physical machines, . . . ) and/or by one or more virtual computing resources (e.g., one virtual machine, two virtual machines, . . . ). A “workload” may also be migrated (e.g., moved) between different computing resource(s) within a host location as well as between different data centers and/or cloud service providers and/or private networks. In some examples, the host locations may be associated with a same cloud service provider (e.g., different regions of a cloud service provider) and/or associated with different cloud service providers. In other examples, the host locations may include private data centers.

In some configurations, metrics used in determining where to dynamically place a workload can be obtained from a cloud service provider and/or some other entity. For instance, EEMs that relate to the energy impact/efficiency of a particular data center/POP can be obtained from different cloud service providers. According to some examples, these EEMs and/or other metrics may be obtained through public means (e.g. an application programming interface (API), a webhook, etc.) and can include parameters such as energy expenditure by unit of compute task. Additional metrics may also be obtained that indicate items, such as power generation (e.g., wind, hydroelectric, nuclear, fossil fuels) used by a host location, a time of day (e.g., morning, afternoon, night), weather (e.g., cloudy, partly cloudy, sunny), and the like.

These EEMs can be used to describe an EEQ for each host location that is available to host the workload. EEQs can change over time due to various conditions (e.g., a solar-powered host location switches to alternate energy sources at night and in cloudy patches). EEQs can be used to evaluate which host location is best suited to perform a migration to, from a “green energy” perspective. In some examples, evaluation of EEQs is maintained by an ETE.

According to some examples, an authorized user may specify what host locations (e.g., cloud service providers, private networks, . . . ) are candidates for hosting one or more workloads. The authorized user may also specify other parameters to use in the selection process (e.g., latency constraints, bandwidth specifications, type of energy used by a possible data center to host a workload, . . . ). In some configurations, a machine learning mechanism may be used to identify what host location(s) to select to host the workloads.

The machine learning mechanism can be used to dynamically place workloads based on various data, such as EEMs, metrics, and/or other specifications. In some examples, training data (e.g., data relating to placing workloads) can be used to create a workload prediction model. The machine learning mechanism may identify data instances, referred to herein as “indicators”, that have a strong correlation with an impending migration of a workload to a different host location. The indicators may include EEMs, performance metrics, and/or other data events associated with migration and placement of workloads. In various examples, the machine learning mechanism may determine weights for individual indicators. The weights may calibrate or apportion the influence of the respective individual indicators. The workload prediction model may be deployed to analyze current data to identify a likelihood of a migration to a new host location. The workload prediction model can also be updated over time automatically by the machine learning mechanism, or some other component, as data correlations evolve over time.

In some configurations, the ETE ranks the host locations (e.g., different POPs of regions of available cloud services) according to the EEQs and/or other parameters as candidate host locations where a workload may be migrated. For example, a POP or data center withing a region of a cloud service provider which derives the majority of power through non-renewable energy sources (such as thermal or coal) would be placed lower in the list of host locations compared to a POP/data center which derives most of the energy through renewable sources (solar, wind).

The ETE, or some other device/component, can perform/obtain latency measurements to determine when to eliminate a candidate host location based on the candidate host location being outside of specified latency bounds. One or more components of a public/private network can measure the performance of hop-by-hop network path(s) between different points within one or more networks.

As an example, a user in Austin, TX may be able to connect to a workload through the following data centers: (1) Cloud Service Provider 1—US East (latency 40 ms), EIQ=highly efficient; (2) Cloud Service Provider 1—US West (latency 50 ms), EIQ=moderately efficient; (3) Cloud Service Provider 1—EU west (latency 110 ms), EIQ=highly efficient; (4) Cloud Service Provider 2—US Central (latency 50 ms), EIQ=inefficient; and (5) Cloud Service Provider 3—US West (latency 50 ms), EIQ=inefficient.

As briefly discussed above, the ETE may use the latency measurements, and/or other metrics to discard host locations. In the current example, if the latency is specified to be less than 100 ms, the third data center from Cloud Service Provider 1—EU west can be discarded by the ETE as the latency measurement is beyond the specified latency constraint for the workload. The ETE may also remove data centers that have an EEQ that is below a specified threshold. Also, the host location(s) with inefficient EEQs are discarded as candidate POPs for a workload. In some configurations, the ETE generates a ranking of the remaining host locations to a derived green rating (the EEQ).

According to some examples, other metrics may also be used to assist in determining a suitable candidate. These metrics may include but are not limited to packet loss metrics, latency metrics, jitter metrics, available bandwidth, capacity, response time metrics, network reachability, path changes, availability metrics, connect time metrics, and the like. When a suitable candidate host location meets both the performance and EEQ specifications is determined, the workload can be migrated. If no suitable host location is found, the workload may be kept in the current data center and is not migrated.

Over time, the EEQ associated with a host location is updated. When the EEQ falls below a minimum acceptable level/threshold (e.g., for a period of time), the ETE causes the workload to be migrated to a host location where both the performance and EEQ can be better optimized. In some examples, the ETE signals another component to migrate the workload. According to some configurations, the ETE computes the difference between the expected gain in EEQ and the energy cost of migrating the task. If the gain exceeds the cost, then the ETE may recommend/cause the workload to be migrated. In other examples, workloads can be hosted in different data centers.

According to some configurations, the ETE may also store telemetry data that indicates where a workload is hosted. When a user places a Domain Name System (DNS) request for connecting to the workload, a DNS resolver (e.g., a secure network gateway) accesses the telemetry data from the ETE. In some examples, the ETE may compare this data with a preference for a specific user account. For example, a profile associated with the user account may contain preferences which the user can opt-in (per-application, or for all applications). These preferences can include but are not limited to prefer a workload with a lower EEQ, choose a workload with a lower EEQ with conditions (e.g. if within latency requirements for the workload), choose the nearest host location, and the like.

In addition to optimizing the selection of host locations based on performance and energy efficiency, the techniques described herein can track a user's energy consumption. The ETE can accrue the energy consumption as an accumulative metric that can be provided to the user and/or some other component/entity. Specifically, the resources consumed by given workloads are known, as is the EEQ of the host location, and as such the users can be provided with not only resource consumption statistics for billing purposes, but also energy consumption statistics to aid in meeting their green targets. For example, a cloud provider could report not only the user's total resource usage (in terms of CPU cycles, memory, disk space, etc.) per month, from which the monthly charge is derived from, but also the total energy that the customer consumed, which could be expressed both in kWH, as well as how much tons of carbon dioxide (CO2)was emitted to generate the energy.

Furthermore, cloud providers can differentiate themselves based on the energy impact of their data centers. Continuing the example, Cloud Provider A may report that a user consumed 4300 kWh for the month on all their cloud resources, which (per Cloud Provider A's energy efficiency quotient) required the equivalent of 1.0 tons of CO2 to produce. In some examples, this data can be compared to other cloud providers. For instance, if the users had their workloads in Cloud Provider B they would have generated 1.2 tons of CO2 to produce the equivalent energy, whereas Cloud Provider C would have generated 1.25 tons of CO2, and so forth. Such accounting, feedback and comparisons would drive not only competitive differentiation for cloud providers, but also enable customers to make more informed decisions regarding sustainability and environmental impact.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

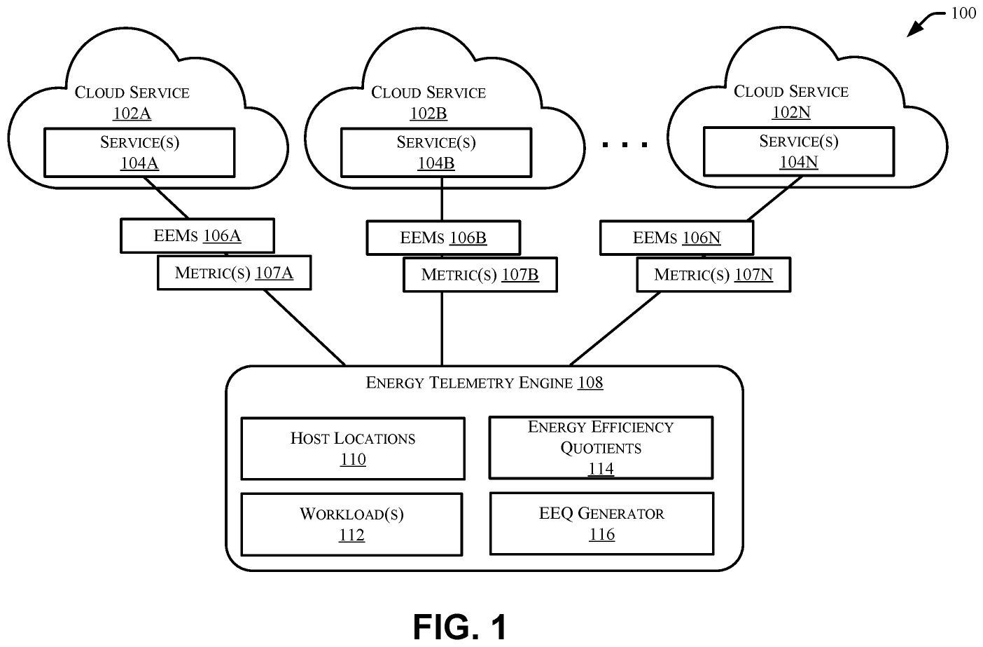

FIG. 1 illustrates a system that uses an energy telemetry engine 108 to assist in dynamically placing workloads using cloud service energy impact. As illustrated in FIG. 1, cloud services 102, such as cloud services 102A-102N communicate with the ETE 108 (as illustrated by the solid lines between the service(s) 104A-104N and the ETE 108). Cloud services 102A-102N may be referred to collectively herein as “cloud services 102” or individually as “cloud service 102”.

Each of the cloud services 102 may be provided by a different cloud service provider and/or be a different region of a cloud service provider. For example, cloud service 102A may be a first data center within a first region provided by a first cloud service provider, cloud service 102B may be a second data center within a second region provided by the first cloud service provider, and cloud service 102N may be provided by a different cloud service provider. According to some configurations, the energy telemetry engine 108 may also be connected to one or more private networks (not shown).

As illustrated in system 100, an ETE 108 can be used to perform operations to cause a workload to be hosted by a cloud service 102 selected from the available cloud services 102 that are able to host a workload. Instead of selecting only a single cloud service to host a workload, techniques described herein allow a workload to be moved between different cloud service(s) based on EEQs calculated from current energy efficiency metrics (EEMs) associated with the cloud services 102 as well as on one or more other metrics (e.g., latency, bandwidth, . . . ). In this way, workloads may be dynamically placed using the current cloud service energy efficiencies.

As briefly discussed above, the ETE 108 and/or some other device/component obtains EEMs 106, such as EEMs 106A-106N, for different data centers of cloud services 102 that can be used to host one or more workloads. The ETE 108 and/or some other device/component can also obtain other metric(s) 107A-107N, for different data centers of cloud services 102 that can be used to assist in determining whether or a cloud service 102 meets specified conditions (e.g., latency, bandwidth, . . . ) to host one or more workloads 112.

In some configurations, the EEMs 106 and the metric(s) 107 used in determining where to dynamically place a workload 112 can be obtained from a cloud service 102 and/or some other entity. For instance, the EEMs that relate to a level of sustainability of a particular data center/POP may be obtained directly from a cloud service 102 and/or some other source that provides data indicating the level of sustainability of the cloud service 102. According to some examples, these EEMs 106 and/or the metric(s) 107 may be obtained through public means such as an application programming interface (API), a webhook, and the like, and can include parameters such as energy expenditure by unit of compute task. The EEMs 107 and/or the metrics 107 may indicate data, such as but not limited power generation (e.g., wind, hydroelectric, nuclear, fossil fuels) used by the cloud services 102, a time of day (e.g., morning, afternoon, night), weather (e.g., cloudy, partly cloudy, sunny), and the like.

In some configurations, the ETE 108 generates an EEQ 114 for each of the host locations (e.g., cloud services 102) that indicates an energy efficiency (e.g., the carbon footprint) for the cloud service 102A. Many different techniques may be used to generate the EEQs 114. For example, the ETE 108 may use an EEQ generator 116 to generate an EEQ for each of the possible host locations (e.g., cloud services 102). In some configurations, the EEQ generator 116 uses a combination of the received EEMs 106 to generate a score and/or classification that indicates the energy efficiency of the host location. In other examples, the EEQ generator 116 may utilize a machine learning mechanism to generate the EEQs 114.

The machine learning mechanism can use a workload prediction model that is trained using various data, such as EEMs 106, metrics 107, and/or other data. As briefly discussed above, the machine learning mechanism may identify indicators that have a strong correlation with an impending migration of a workload to a different host location. The indicators may include EEMs 106, metric(s) 107, and/or other data/events associated with migration and placement of workloads. In various examples, the machine learning mechanism may determine weights for individual indicators. The weights may calibrate or apportion the influence of the respective individual indicators. The workload prediction model may be deployed to analyze current data to identify when a workload should be migrated to a new host location. The workload prediction model can also be updated over time automatically by the machine learning mechanism, or some other component, as data correlations evolve over time.

These EEQs 114 can be stored by the ETE 108 and used by the ETE 108 to describe an EEQ for each host location that is available to host the workload. EEQs 114 can change over time due to various conditions (e.g., a solar-powered host location switches to alternate energy sources at night and in cloudy patches). EEQs 114 can be used to evaluate which host location is best suited to perform a migration to, from a “green energy” perspective.

According to some configurations, the ETE 108 ranks the different cloud services 102 according to the respective EEQ for the cloud service 102. For example, the ranking may go from most energy efficient and green to least energy efficient. In other examples, the ETE 108 may classify the host locations in two or more classifications, such as “highly efficient”, “moderately efficient”, “inefficient”, and the like. In yet other examples, the ETE 108 may provide a score that indicates the efficiency of the host location (e.g., 0-100 with 0 being the least efficient). In some configurations, the ETE 108 may remove a cloud service 102 as a candidate host location when the EEQ falls below a specified threshold.

As briefly discussed above, one or more other metrics (e.g., latency, bandwidth, . . . ) may be used to identify any host locations, such as cloud services 102, that do not meet specified conditions (e.g., latency constraints, bandwidth constraints, . . . ). In some examples, the ETE 108 is configured to determine when a cloud service 102 is outside a specified latency bound (e.g., 50 ms, 100 ms, . . . ). In the current example, the ETE 108 may determine the latency between two or more points such as between the ETE 108 and one or more points within each of the cloud services 102. In the current example of FIG. 1, if the latency is specified to be less than 150 ms, the ETE 108 may obtain latency measurements and/or perform latency measurements to determine whether the cloud service 102 meets the specified condition. When the cloud service 102 does not meet the specified condition, the cloud service 102 may be removed from consideration as a host location.

According to some examples, other metrics may also be used to assist in determining a suitable candidate. These metric(s) 107 may also be used in placing workloads 112 on a cloud service 102 based on cloud service energy efficiency. The metric(s) may include but are not limited to packet loss metrics, latency metrics, jitter metrics, available bandwidth, capacity, response time metrics, network reachability, path changes, availability metrics, connect time metrics, and the like. When a suitable candidate host location meets both the performance and EEQ specifications is determined by the ETE 10, a workload 112 can be migrated to the selected host location. If no suitable host location is found, the workload 112 may be kept in the current data center and is not migrated.

When a suitable host location is determined, the workload may be placed by the ETE 108 and/or some other device/component/service onto one or more resources of the selected cloud service. While ETE 108 is shown separately from the cloud services 102A-102N, the energy telemetry engine 108 may be part of one or more of the cloud services 102A-102N. For example, the ETE 108 may be part of service(s) 104A of cloud service 102A and/or other cloud services 102B-102N.

Over time, the EEQs 114 are periodically updated (e.g., hourly, every two hours, daily, . . . ) to determine if the EEQ for a particular cloud service 102 has changed. When the EEQ for a particular host location falls below a minimum acceptable level for a period of time, the ETE 108 may cause the workload to be migrated to a different host location where both the performance and EEQ can be better optimized. In some examples, the ETE signals another component to migrate the workload. According to some configurations, the ETE computes the difference between the expected gain in EIQ and the energy cost of migrating the task. If the gain exceeds the cost, then the ETE may recommend/cause the workload to be migrated. In other examples, workloads can be hosted in different data centers.

In further examples, an authorized user may specify what cloud services 120 are candidates for hosting one or more workloads 112. The authorized user may also specify other parameters to use in the selection process (e.g., latency constraints, bandwidth specifications, type of energy used by a possible data center to host a workload, . . . ).

In addition to optimizing the selection of host locations based on performance and energy efficiency, the techniques described herein can track a user's energy consumption for workloads hosted in one or more cloud services 102. For example, the ETE108 can accrue the energy consumption as an accumulative metric that can be provided to the user and/or some other component/entity (not shown). Specifically, the resources consumed by given workloads are known, as is the energy efficiency of the host location, and as such the users can be provided with not only resource consumption statistics for billing purposes, but also energy consumption statistics to aid in meeting their green targets. For example, a cloud provider could report not only the user's total resource usage (in terms of CPU cycles, memory, disk space, etc.) per month, from which the monthly charge is derived from, but also the total energy that the customer consumed, which could be expressed both in kWH, as well as how much tons of carbon dioxide (CO2)was emitted to generate the energy.

Furthermore, cloud providers of the different cloud services 102 can differentiate themselves based on how green they are. For instance, cloud service 102A may report that a user consumed 2500 kWh for the month on all their cloud resources, which (per the EEQ for the cloud service 102A) required the equivalent of 0.75 tons of CO2 to produce. In some examples, this data can be compared to other cloud services 102. For instance, the ETE 108 may provide data to a user that indicates that if the workloads were hosted by cloud service 102B that their workloads would have generated 1.5 tons of CO2 to produce the equivalent energy, whereas cloud service 102N would have generated 1.25 tons of CO2, and so forth. Such accounting, feedback and comparisons provide competitive differentiation for different cloud service providers and also enables users to make more informed decisions regarding sustainability and environmental impact.

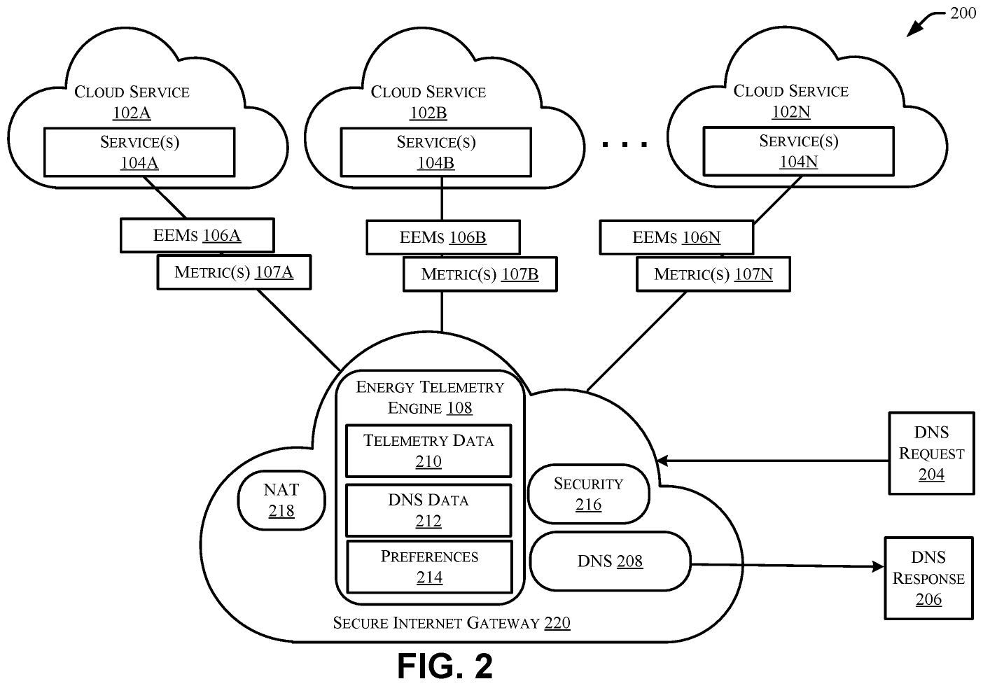

FIG. 2 illustrates a system 200 that uses an energy telemetry engine 108 to help dynamically place workloads in different cloud services 102. FIG. 2 is similar to FIG. 1 but includes a Secure Internet Gateway (SIG) 220 that may be used to assist in dynamically placing workloads using cloud service 102 energy efficiency quotients and/or other data. Referring to FIG. 2, energy telemetry engine 108 is configured to send and receive data to/ from different networks, such as to service(s) 114A of cloud service 102A and service(s) 114B of cloud service 102B, via the SIG 220. SIG 220 can be configured to receive DNS requests, such as DNS request 204 and provide DNS responses, such as DNS response 206 from DNS 208. SIG 220 can also include network address translation (NAT) 218 component.

According to some configurations, the SIG 220 is a cloud-based Secure Internet Gateway (SIG) platform that provides multiple levels of defense against internet-based threats. In some examples, the SIG 220 includes security component 216 that integrates a secure web gateway, a firewall, DNS-layer security, and cloud access security broker (CASB) functionality. A Cloud Access Security Broker (CASB) acts as an intermediary between cloud providers and cloud consumers to enforce an organization's security policies for cloud application access and usage.

In some examples, the ETE 108 stores telemetry data 210 that assists in determining the hosting location (e.g., a cloud service 102) where a workload is currently hosted. When a Domain Name System (DNS) request 204 is received for connecting to the workload, a DNS resolver associated with SIG 220 accesses the telemetry data 210 from the ETE 108 to determine the location of the workload. According to some configurations, the ETE 108 compares the telemetry data 210 with data in preference 214 that are associated with a user. For example, a profile associated with a user may contain preferences which the user can opt-in (per-application, or for all applications).

These preferences can include but are not limited to prefer a workload with a lower EEQ, choose a workload with a lower EEQ with conditions (e.g. if within latency requirements for the workload), choose the nearest host location, and the like. In some examples, the ETE 108 and/or some other component may maintain a list of DNS data 212, such as DNS address records with their associated EEQ that may be stored in the DNS metadata field (DNS-AS field). When the user-preference is matched by SIG 220, the DNS resolver chooses the host location (e.g., a cloud POP) which is ranked higher in the EEQ rating.

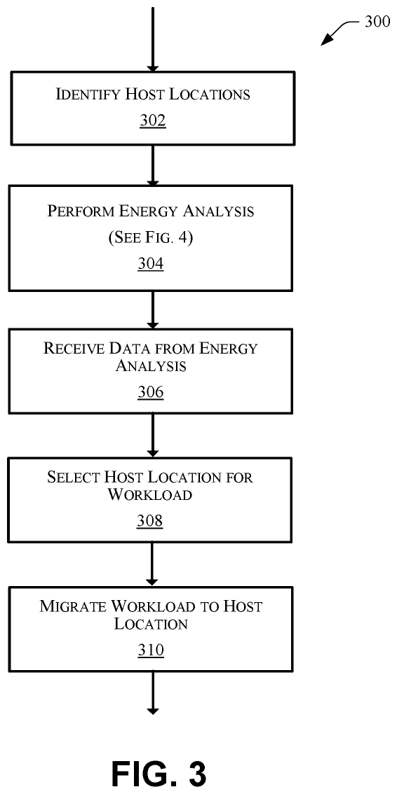

FIG. 3 is a flowchart 300 illustrating a process for dynamically placing workloads using cloud service energy efficiency in a multi-cloud service environment.

At 302, the host locations are identified. As discussed above, the host locations may be one or more cloud services, such as cloud services 102A-102N as illustrated in FIG. 1 and FIG. 2, and/or one or more data centers of one or more cloud service providers. In some examples, the host locations are determined from preferences 214 associated with a user that specifies the host locations.

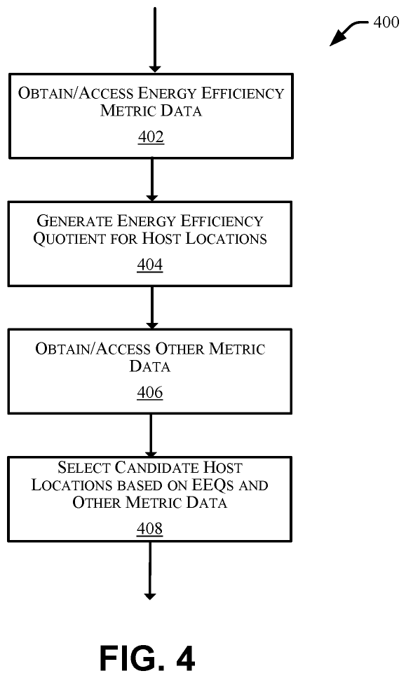

At 304, an energy analysis is performed. In some examples, the energy analysis may be performed by an ETE 108, or by some other device or component. Generally, the energy analysis includes determining an EEQ for each of the different host locations that can be used to host a workload 112. The energy analysis may also use other metrics that indicate a characteristic of the host location, such as latency, bandwidth, and the like. In some configuration, the ETE 108 periodically (e.g., each hour, or some other time period) updates the energy analysis. See FIG. 4 and related discussion for more information.

At 306, data from the energy analysis is received. As discussed above, the energy analysis may be performed by the energy telemetry engine 108 may include an EEQ from each of the different host locations. In some examples, the data from the energy analysis may also include a classification, score, and/or ranking of the different host locations that indicate the energy efficiency of the host locations for the host locations that meet any specified conditions (e.g., latency under a specified value, bandwidth greater than a specified value, and the like).

At 308, the host location for the workload is selected. As discussed above, the host location may be selected based on different criteria, such as a ranking of host locations, a classification of the host locations, a score of the host locations, and/or other data. In some examples, a machine learning mechanism may be used to select the host location.

At 310, the workload is migrated to the selected host location. As discussed above, the ETE 108 may cause a workload to be migrated to computing resources of a selected data center of a cloud service provider 102.

FIG. 4 is a flowchart 400 illustrating a process for performing energy analysis for different cloud services.

At 402, EEM data is obtained for the different candidate host locations. As discussed above, the EEMs 106 may be obtained through public means (e.g. an API, a webhook, etc.) and can include parameters such as energy expenditure by unit of compute task. The EEMs 106 may also indicate information about the host locations, such as power generation (e.g., wind, hydroelectric, nuclear, fossil fuels) used by a host location, a time of day (e.g., morning, afternoon, night), weather (e.g., cloudy, partly cloudy, sunny), and the like.

At 404, the EEQs for the different host locations are generated. As discussed above, the ETE 108 generates an EEQ 114 for each of the host locations (e.g., cloud services 102) that indicates an energy efficiency (e.g., the carbon footprint) for the cloud service 102A. Many different techniques may be used to generate the EEQs 114. For example, the ETE 108 may use an EEQ generator 116 to generate an EEQ for each of the possible host locations (e.g., cloud services 102). In some configurations, the EEQ generator 116 uses a combination of the received EEMs 106 to generate a score and/or classification that indicates the energy efficiency of the host location. In other examples, the EEQ generator 116 may utilize a machine learning mechanism to generate the EEQs 114.

At 406, other metric data may be obtained/accessed. As discussed above, the metric(s)107 may be obtained through public means (e.g. an API, a webhook, etc.) and can include parameters such as energy expenditure by unit of compute task. The metric(s) 107 may include but are not limited to packet loss metrics, latency metrics, jitter metrics, available bandwidth, capacity, response time metrics, network reachability, path changes, availability metrics, connect time metrics, and the like.

At 408, the candidate host locations may be selected based on EEQs and the other metric data. As discussed above, the ETE 108 may select the host locations that are candidate host locations when a host location is within a specified efficiency and when the host location performs at the specified parameters (e.g., less than a specified latency).

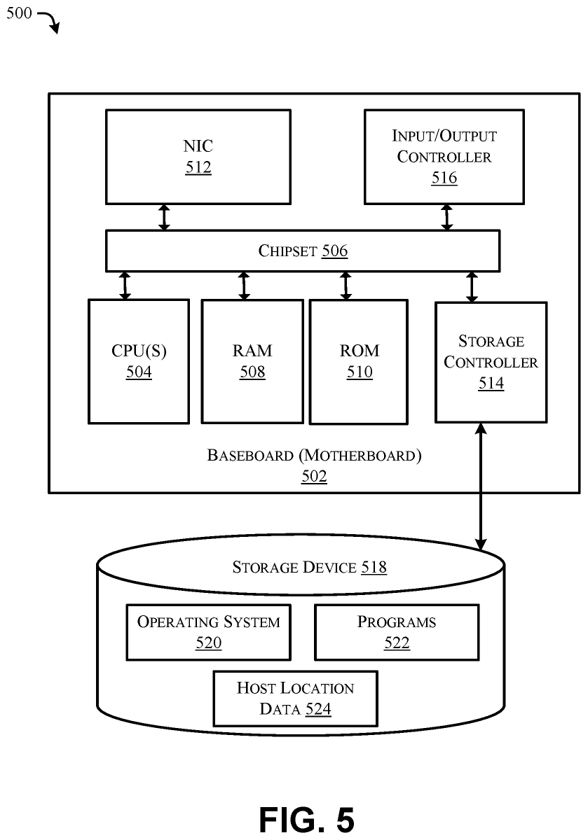

FIG. 5 illustrates an example computer architecture for a computer 500 capable of executing program components for implementing the functionality described above. The computer architecture shown in FIG. 5 illustrates an architecture of a server computer, workstation, desktop computer, laptop, tablet, network appliance, e-reader, smartphone, network switch, or other computing device, and can be utilized to execute any of the software components presented herein. The computer 500 may, in some examples, correspond to a network infrastructure device discussed herein.

The computer 500 includes a baseboard 502, or “motherboard,” which may be a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be, for example, standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein. As illustrated in FIG. 5, the ROM 510 or NVRAM can also store data usable by the computer 500 to generate and/or process attestation information in messages exchanged among the computer 500 and other devices. In other examples, this data may be stored elsewhere, such as in RAM 508.

The computer 500 can operate in a networked environment using logical connections to remote computing devices and computer systems through a network. For example, the chipset 506 can include functionality for providing network connectivity through a Network Interface Controller (NIC) 512, such as a gigabit Ethernet adapter. The NIC 512 can connect the computer 500 to other computing devices over a network. It should be appreciated that multiple NICs 512 can be present in the computer 500, connecting the computer to other types of networks and remote computer systems. In some instances, the NICs 512 may include at least one ingress port and/or at least one egress port. An input/output controller 516 may be provided for other types of input/output.

The computer 500 can be connected to a storage device 518 that provides non-volatile storage for the computer. The storage device 518 can store an operating system 520, programs 522, and data 524, for example. The storage device 518 can be connected to the computer 500 through a storage controller 514 connected to the chipset 506. The storage device 518 can include one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The data 524 may include, for example, dynamic proxy mapping data.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like. For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the storage device 518 described above, the computer 500 can have access to other computer-readable storage media to store and retrieve information, such as program modules, data structures, or other data, including data to generate and/or process attestation information. It should be appreciated by those skilled in the art that computer-readable storage media is any available media that provides for the non-transitory storage of data and that can be accessed by the computer 500.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method comprising:
identifying host locations to host a workload, wherein individual ones of the host locations include computing resources provided by a cloud service provider;
performing an energy analysis that indicates an energy efficiency for the individual ones of the host locations, wherein performing the energy analysis comprises generating, via an energy telemetry engine (ETE), an energy efficiency quotient (EEQ) for at least a portion of the individual one of the host locations;
selecting, via the ETE communicatively coupled to the host locations, a host location from the host locations to host the workload; and
causing the workload to be migrated to the host location.

2. The method of claim 1, further comprising selecting a different host location to host the workload based, at least in part, on a change in value of the EEQ of the host location.

3. The method of claim 1, further comprising generating, via the ETE, a ranking the host locations according to the energy analysis, and wherein selecting the host location is based, at least in part, on the ranking.

4. The method of claim 1, further comprising obtaining energy efficiency metrics (EEMs) and one or more other metrics associated with the individual ones of the host locations, wherein the EEMs relate to a level of sustainability and the one or more other metrics relate to one or more performance characteristics.

5. The method of claim 4, further comprising removing one or more of the host locations to host the workload based, at least in part, on one or more other metrics, wherein the one or more other metrics include at least one of a latency metric, a bandwidth metric, and a type of energy used metric.

6. The method of claim 1, wherein the host locations include at least one of different data centers of a cloud service provider or different cloud services.

7. The method of claim 1, further comprising tracking an energy consumption of the workload over a time period, wherein the workload is migrated from the host location to at least one or more other host locations over the time period.

8. The method of claim 1, further comprising associating the EEQ with a domain name system address record.

9. A system, comprising:
a plurality of host locations, wherein the plurality of host locations include a plurality of data centers associated with one or more cloud services; and
an energy telemetry engine, comprising:
one or more processors; and
one or more non-transitory computer-readable media storing computer-executable instructions that, when executed by the one or more processors, cause the one or more processors to perform operations of:
identifying host locations to host a workload, wherein individual ones of the host locations include computing resources provided by a cloud service provider;
performing an energy analysis that indicates an energy efficiency for the individual ones of the host locations, wherein performing the energy analysis comprises generating, via an energy telemetry engine (ETE), an energy efficiency quotient (EEQ) for at least a portion of the individual one of the host locations;
selecting, the ETE communicatively coupled to the host locations, a host location from the host locations to host the workload; and
causing the workload to be migrated to the host location.

10. The system of claim 9, the operations further comprising selecting a different host location to host the workload based, at least in part, on a change in value of the EEQ of the host location.

11. The system of claim 9, the operations further comprising generating, via the ETE, a ranking the host locations according to the energy analysis, and wherein selecting the host location is based, at least in part, on the ranking.

12. The system of claim 9, the operations further comprising obtaining energy efficiency metrics (EEMs) and one or more other metrics associated with the individual ones of the host locations, wherein the EEMs relate to a level of sustainability and the one or more other metrics relate to one or more performance characteristics.

13. The system of claim 12, further comprising removing one or more of the host locations to host the workload based, at least in part, on one or more other metrics, wherein the one or more other metrics include at least one of a latency metric, a bandwidth metric, and a type of energy used metric.

14. The system of claim 9, wherein the host locations include at least one of different data centers of a cloud service provider or different cloud services.

15. The system of claim 9, the operations further comprising tracking an energy consumption of the workload over a time period, wherein the workload is migrated from the host location to at least one or more other host locations over the time period.

16. The system of claim 9, the operations further comprising associating the EEQ with a domain name system address record.

17. A non-transitory computer-readable media storing computer-executable instructions that, when executed by one or more processors, cause the one or more processors to perform operations of:
identifying host locations to host a workload, wherein individual ones of the host locations include computing resources provided by a cloud service provider;
performing an energy analysis that indicates an energy efficiency for the individual ones of the host locations, wherein performing the energy analysis comprises generating an energy efficiency quotient (EEQ) for at least a portion of the individual one of the host locations;
selecting a host location from the host locations to host the workload; and
causing the workload to be migrated to the host location.

18. The non-transitory computer-readable media of claim 17, the operations further comprising generating a ranking the host locations according to the energy analysis, and wherein selecting the host location is based, at least in part, on the ranking.

19. The non-transitory computer-readable media of claim 17, the operations further comprising obtaining energy efficiency metrics (EEMs) and one or more other metrics associated with the individual ones of the host locations, wherein the EEMs relate to a level of sustainability and the one or more other metrics relate to one or more performance characteristics.

20. The non-transitory computer-readable media of claim 17, further comprising removing one or more of the host locations to host the workload based, at least in part, on one or more other metrics, wherein the one or more other metrics include at least one of a latency metric, a bandwidth metric, and a type of energy used metric.
